(19) United States
(12) Patent Application Publication
(10) Pub. No.: US 2010/0008510 A1
(43) Pub. Date: Jan. 14, 2010

(54) Method And System For Secure Download Of Firmware

(76) Inventor: Fernando A. Zayas, Loveland, CO (US)

Correspondence Address: PATTERSON & SHERIDAN, L.L.P., 3040 POST OAK BOULEVARD, SUITE 1500, HOUSTON, TX, 77056, US

(21) Appl. No.: 12/171,279

(22) Filed: Jul. 10, 2008

(51) Int. Cl. H04L 9/12; H04L 9/08; G06F 12/14

(52) U.S. Cl. 380/283; 380/44; 713/193; 711/E12.092

(57) ABSTRACT

Firmware is securely downloaded from a host to an information storage device using an encryption key generated by the information storage device. The encryption key is generated in response to a firmware download request by the host. The host encrypts the firmware image with the encryption key and downloads the encrypted firmware image to the information storage device. The information storage device receives the encrypted firmware image, decrypts the firmware image, and updates its firmware with this firmware image.

### BACKGROUND OF THE INVENTION

1. Field of the Invention

Embodiments of the present invention relate generally to information storage devices and, more particularly, to a method and system for updating firmware in information storage devices.

2. Description of the Related Art

In computing, firmware is a computer program that is embedded in a hardware device, for example, a microcontroller. It can also be provided on flash ROMs or as a binary image file that can be uploaded onto existing hardware by a host. As its name suggests, firmware is somewhere between hardware and software, i.e., the programmable content of a hardware device, consisting of machine language instructions for a processor, or the configuration settings for a fixed-function device, gate array, or programmable logic device. Like software, firmware is a computer program that is executed by a microprocessor or a microcontroller, but because firmware is closely tied to the specific piece of hardware for which it has been written, it generally has little meaning outside of device.

Firmware is commonly used in information storage devices, such as disk drives, optical storage devices, solid state storage devices, and magnetic media, among others. A common feature of firmware is that it can be electronically updated post-manufacturing by a host without the need for additional hardware, for example to improve the functionality of the associated hardware and/or to address known bugs in the earlier version of the firmware. Because firmware updates can be modified to change the function of the target device, or a version having known exploitable weaknesses can be loaded onto the device, access to the firmware of an information storage devices is often controlled. For example, in the case of a hard disk drive (HDD), firmware updates reside in an electronics package contained in the hard drive assembly, such as in a flash memory chip. To prevent unauthorized access to the HDD firmware, firmware files, i.e., a firmware image, can be encrypted when downloaded to the HDD, and access to the downloaded firmware image can be controlled by security measures such as password protection of the HDD.

During the download process, in which a host downloads an encrypted version of the firmware to the HDD, unauthorized users may “snoop” the communication traffic taking place between the host and the HDD. For example, a bus analyzer may be used on a laptop to observe commands being sent to the HDD by the laptop's user, and a network analyzer may be used to observe network traffic during a remote-download session to an HDD. Such communication traffic typically includes security-related files, such as the encrypted firmware files, the encryption key needed to decrypt these files, and even the HDD password. Thus security-related files can be observed by an unauthorized user during the download process. Unauthorized knowledge of the encryption key increases the likelihood of encrypted files being decrypted. If an unauthorized user successfully decrypts the encrypted firmware files, all devices of the same type can potentially be attacked.

In light of the above, there is a need for a method of updating firmware for an information storage device that reduces the probability of unauthorized access to the information storage device and the firmware for the information storage device.

### SUMMARY OF THE INVENTION

One or more embodiments of the present invention provide a method for updating firmware for an information storage device, where the firmware is securely downloaded from a host to the information storage device using an encryption key generated by the information storage device.

In one embodiment, a method for updating firmware for an information storage device comprises receiving a request to update firmware from a host, generating an encryption key, transmitting the encryption key to the host, and receiving a new firmware from the host, the new firmware being encrypted with the encryption key.

In another embodiment, a method for updating firmware for an information storage device comprises transmitting a request to update firmware to the information storage device, receiving an encryption key from the information storage device, encrypting a new firmware using the encryption key, and transmitting the encrypted new firmware to the information storage device.

A hard disk drive, according to an embodiment of the invention, comprises a microcontroller and a memory unit storing firmware for the microcontroller, wherein the firmware includes instructions for causing the microcontroller to generate an encryption key in response to a request for downloading a new firmware into the microcontroller.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating an information storage device that may be configured to perform encrypted firmware downloading.

FIG. 2 is a block diagram schematically illustrating components of a printed circuit board in FIG. 1.

FIG. 3 is a block diagram schematically illustrating components of a system-on-chip in FIG. 2.

FIG. 4 is a flow diagram illustrating a method for securely downloading a firmware image to an information storage device, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method and system for securely downloading firmware to an information storage device, in which an encryption key generated by the information storage device is used to encode a firmware image that is downloaded from the host. For higher security, the information storage device receiving the firmware download may generate a unique encryption key for each firmware download request. In addition, the encryption key may itself be encrypted before it is transmitted from the information storage device and to the host.

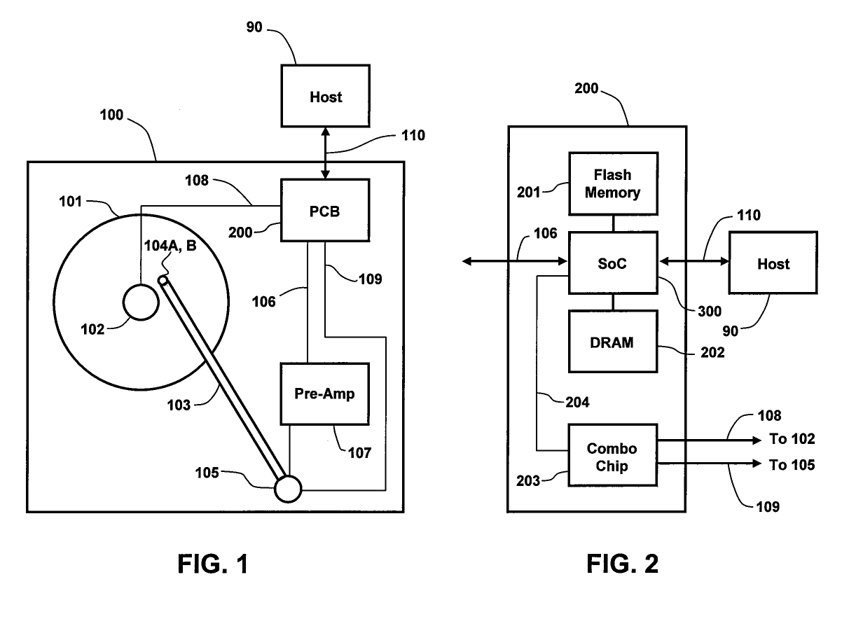

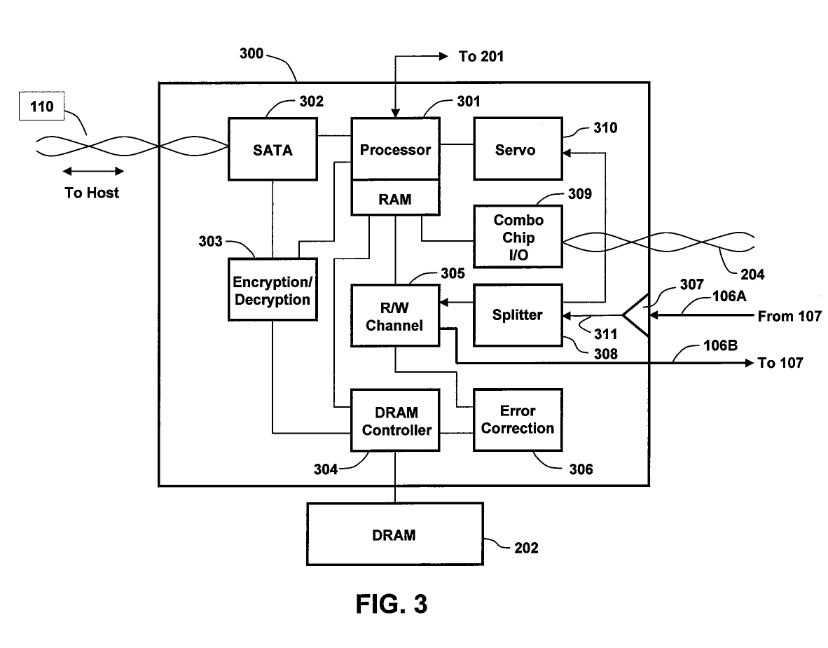

FIG. 1 is a block diagram illustrating an embodiment of an information storage device, disk drive 100, that may be configured to perform encrypted firmware downloading. The mechanical components of disk drive 100 include a magnetic disk 101 rotated by a spindle motor 102, a read/write head 104 disposed on the end of a suspension arm 103. Arm actuator 105 is coupled to suspension arm 103 for moving arm 103 as desired to access different tracks of magnetic disk 101. Electronic components of disk drive 100 include a printed circuit board, PCB 200, and a pre-amplifier 107, the latter of which is electrically coupled to read/write head 104. Pre-amplifier 107 conditions and amplifies signals to and from read/write head 104. PCB 200 includes a system-on-chip (SoC), RAM, and other integrated circuits for operating disk drive 100, and is described below in conjunction with FIGS. 2 and 3. As shown, PCB 200 is electrically coupled to pre-amplifier 107 via electrical connection 106, to spindle motor 102 via electrical connection 108, and to arm actuator 105 via electrical connection 109. PCB 200 communicates with a host 90 via cable 110, which may be an SATA, PATA, SCSI, or other interface. Host 90 may be a laptop computer, a desktop computer, or an appliance such as set-top boxes, televisions and video players, requesting access to one or more sectors of an encryption-enabled storage device contained in the computer or a remote computing device accessing the storage device over a LAN or WAN.

FIG. 2 is a block diagram schematically illustrating components of PCB 200 from FIG. 1. PCB 200 includes an SoC 300, DRAM 202, which may be internal or external to SoC 300, flash memory 201, and a combo chip 203, which drives spindle motor 102 and arm actuator 105. Combo chip 203 also includes voltage regulators for SoC 300, pre-amplifier 107, and the motor controllers contained in SoC 300. As shown, flash memory 201 and DRAM 202 are coupled to SoC 300, which interfaces with the host via cable 110, pre-amplifier 107 via electrical connection 106, and combo chip 203 via serial bus 204. In some embodiments, flash memory 201 resides in SoC 300. Firmware for disk drive 100 resides in flash memory 201.

In alternative configurations, a small portion of the firmware that is not changeable resides in a read-only memory within SoC 300 and the bulk of the firmware resides on magnetic disk 101 and loaded shortly after power up. The firmware residing on magnetic disk 101 may be updated in accordance with embodiments of the invention described below.

FIG. 3 is a block diagram schematically illustrating components of SoC 300 from FIG. 2. SoC 300 is an application-specific integrated circuit (ASIC) configured to perform the control and encryption/decryption operations necessary for disk drive 100 to securely download firmware. SoC 300 includes a number of functional blocks designed to perform particular functions. Processor 301 is a microcontroller configured to control the operation of disk drive 100 and includes RAM and input/output functionality for communication with the other functional blocks of SoC 300, as shown. In one embodiment, processor 301 may be configured with flash memory 201 internally, rather than positioned nearby on PCB 200. SATA block 302 is an input/output block contained in SoC 300 that sends and receives signals to and from the host via cable 110. Combo chip I/O block 309 is an I/O block dedicated to communication between processor 301 and combo chip 203 via serial bus 204. Processor 301 is also configured to encrypt and decrypt data traffic between disk drive 100 and a host, particularly security-related traffic, such as encryption keys.

Encryption/decryption block 303, which is under the control of processor 301, is positioned in the data path between SATA block 302 and all other components of SoC 300 to encrypt incoming data for secure storage and decrypt outgoing data for use by the host. That is, encryption/decryption block 303 receives and encrypts input data (e.g., write data) from the host via SATA block 302, and decrypts and transmits output data (e.g., read data accessed from disk drive 100) to the host via SATA block 302. Encryption/decryption block 303 includes state machines that implement the desired encryption algorithms as well as memory for holding encryption keys and for buffering data during encryption/decryption of data traffic. In operation, encryption/decryption block 303 receives data from the host in unencrypted form. If appropriate encryption keys are provided for use with the incoming data, said data is encrypted by encryption/decryption block 303 and stored, either in DRAM 202 or on magnetic disk 101. When the host retrieves stored data, encryption/decryption block 303 decrypts the data prior to transmission by SATA block 302, so that the host receives unencrypted data.

DRAM controller 304 refreshes DRAM 202 and arbitrates the use of DRAM 202, making DRAM 202 accessible to encryption/decryption block 303, processor 301, read/write channel 305, and error correcting and generating block 306, as needed for the proper operation of disk drive 100. DRAM 202 serves as a DRAM buffer for data being written to or read from magnetic disk 101 and for data received from the host after encryption. DRAM 202 may be external to SoC 300 as shown, or, alternatively, may make up one of the functional blocks contained therein. For error-free retrieval of data from magnetic disk 101, error correction block 306 applies error correction to data read from magnetic disk 101 before the data is buffered in DRAM 202 for decryption and transmission to the host. In addition, when data is being written to magnetic disk 101, error correction block 306 appends information to said data to allow error correction upon retrieval of the data from magnetic disk 101.

In order for the host to retrieve data from magnetic disk 101, data is read from magnetic disk 101 by read/write head 104, conditioned by pre-amplifier 107, and carried as an analog signal by electrical connection 106A to analog-to-digital converter 307. Analog-to-digital converter 307 converts the analog signal to a digital signal 311, which is transmitted to a splitter block 308. From digital signal 311, splitter block 308 sends the appropriate servo-related data to servo block 310 for optimal control of spindle motor 102 and arm actuator 103 using motor 105. Splitter block 308 sends the data requested by the host to read/write channel 305, which routes the data through error correction block 306 to DRAM 202 for buffering until said data can be decrypted and transmitted to the host.

For storage of data on magnetic disk 101 by the host, encrypted data is buffered in DRAM 202 as necessary and routed through error correction block 306 and then to read/write channel 305. Read/write channel 305 then sends a digital signal via electrical connection 106B to pre-amplifier 107, which conditions and amplifies the digital signal for reads/write head 104 to write the encrypted data onto magnetic disk 101. One of skill in the art will appreciate that encrypted data resides in the storage media contained in disk drive 100, i.e., DRAM 202 and magnetic disk 101.

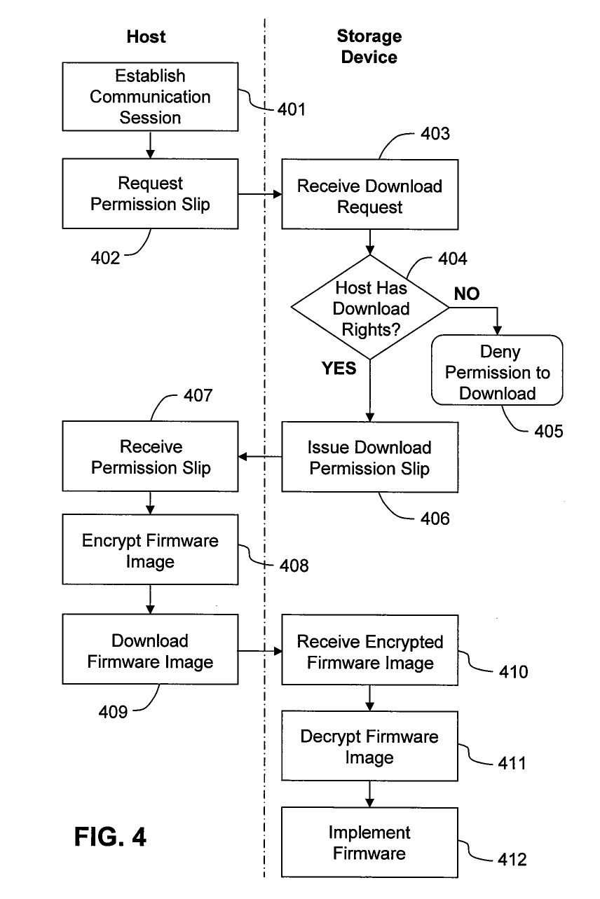

FIG. 4 is a flow diagram illustrating a method 400 for securely downloading a firmware image to an information storage device, such as a hard disk drive, according to an embodiment of the invention. For example, method 400, as described herein, may be performed with a disk drive similar in organization and operation to disk drive 100 in FIG. 1. The steps making up method 400 are arranged in two columns, where the steps performed by the host are located in the left column and the steps performed by the storage device are located in the right column.

In step 401, a communication session is established between a host and a storage device. In the embodiment illustrated herein, the communication session is encrypted so that anyone watching the traffic over the network would not be able to read the transmitted messages. The host and the storage device establishes the communication session when a user logs into the storage device-much in the same way that a network user logs into a network terminal. The host may be a laptop or desktop computer requesting access, i.e., read/write privileges, to one or more sectors of an encryption-enabled storage device contained in the computer, such as a hard disk drive. Alternatively, the host may be a remote computing device, e.g., a network computer or terminal, accessing the storage device over a LAN or WAN. To prevent access to the storage device by unauthorized users, some or all of the storage device is password protected, as well as the ability to download firmware for the storage device. In one embodiment, for example, a host is required to transmit some form of user credentials to the storage device, such as a user ID and an associated access code, to establish a specific permission level. Different permission levels provide access to different portions of the storage device and/or permission to download firmware to the storage device.

In one embodiment, a double-password scheme is used to authenticate a login. In such an approach, a two-part password and a unique key encryption key (KEK) is associated with each “user.”. The first part P1 of the password, second part P2 of the password, and the KEK are fixed-value random numbers or alpha-numeric combinations, different for each user, and used as encryption keys as described below. P1, P2, and the KEK are large numbers, e.g., 256 bit, and therefore difficult to guess. The KEK may be used, for example, in an advanced encryption standard (AES) key-wrap protocol, and is known by, i.e., resides in, both the storage device and host memory. However, the two-part password is not retained in an unencrypted form in the storage device. Thus, all the information required for a particular host login does not reside on the storage device. Instead, when a user is first established on a storage device, P2 is encrypted using P1 as an encryption key and is stored on the storage device. The unencrypted P1 is then erased from the storage device as part of the user setup procedure. P2 is encrypted using P1 as an encryption key using AES-256 in one embodiment.

To establish a secure communication session between a host and a storage device, P1 and P2 are sent from the host to the storage device in a first package, Package1. To form Package1, P2 is mixed with a random number or alphanumeric combination R1 selected by host software. One example of mixing two numbers known in the art is the XOR operation. P1 is then concatenated or otherwise packaged with the P2-R1 combination. The Packagel is then key-wrapped using the KEK associated with the host, and transmitted to the storage device. The storage device unwraps Packagel using the KEK, which resides in the storage device. The storage device then uses P1 as the encryption key to decrypt the encrypted version of P2 residing in the storage device that is associated with the host currently logging in. Given P2, the storage device can then unmix P2 and R1. R1 is now known by the host and the storage device and can be used as a unique session key or as part of a two-part unique session key. The use of a unique session key ensures that even with complete knowledge of the KEK for a given host and the one-way function associated with the KEK, unauthorized personnel cannot decrypt data traffic between the storage device and the host.

For a more robust session key, a second random number or alphanumeric combination R2 is generated by the storage device in the following manner. Upon determination of P1, P2, and R1, the storage device mixes R2 with P2 (e.g., by performing an XOR operation on R2 and P2) to form Package2. The storage device key-wraps Package2 using the KEK and transmits the encrypted Package2 to the host. The host then unwraps Package2 and unmixes R2 from P2, so that both the host and the storage device know the values of R1 and R2 and can therefore use the combination of R1 and R2 as a unique session key. Thenceforth, data traffic between the host and the storage device can be encrypted using the unique session key made up of R1 and R2.

Thus, for added security, a unique session key can be established between the host and the storage device without transmitting any encryption keys in the clear, and without storing on the storage device all the information necessary for establishing storage device access. Once the secure communication session has been established, subsequent data traffic between the host and the storage device is protected from snooping, since all data traffic is encrypted using the unique session key made up of R1 and R2. A detailed description of these techniques are also described in co-pending U.S. patent application Ser. No. 12/060,182, entitled “Storage Device and Encryption Method,” filed Mar. 31, 2008. One of skill in the art will appreciate that other login schemes may also be used in step 401 to establish a secure communication session between a host and a storage device.

In step 402, the user requests, through the host, permission to download firmware to the storage device. This request is made via the secure data exchange provided by the unique session key created from R1 and R2.

In step 403, the storage device receives the request by decrypting the data traffic received from the host with the unique session key.

In step 404, the storage device confirms whether the user has firmware download rights. Such rights are defined in the storage device when the user is initially established. For example, download rights are typically assigned to a user performing the administration role.

In step 405, in which the storage device has determined that the user does not have firmware download rights, permission for the user to download firmware to the storage device is denied.

In step 406, in which the storage device has determined that the user does have firmware download rights, the storage device issues a “permission slip.”One example of a permission slip is an encryption key. For added security, the permission slip may be a single-use encryption key based on a random number generated by the storage device, and is thus valid for a single firmware download. If the host requests permission for another firmware download, steps 403-405 are repeated by the storage device. For security against snooping, the permission slip is key-wrapped using the KEK and the data traffic that includes the wrapped permission slip is encrypted using the unique session key based on R1 and R2.

In step 407, the host receives and decrypts the encrypted permission slip provided by the storage device using the session key and the KEK to unwrap the two layers of encryption.

In step 408, the host encrypts the firmware image using the permission slip as an encryption key. In one embodiment, an additional layer of encryption using the session key is used if the encrypted firmware image is delivered to the disk drive using the same style of traffic as was used to obtain the permission slip.

In step 409, the host downloads the firmware to the storage device. In one embodiment, this is done using the standard ATA download microcode command.

In step 410, the storage device receives the encrypted firmware download.

In step 411, the storage device decrypts the encrypted firmware download using the permission slip and, if an additional layer of encryption was used, using the session key first.

In step 412, the storage device implements the firmware download into the requisite flash memory block of the device. In the embodiment where the changeable part of the firmware resides on the magnetic disk, this step would update the firmware residing on the magnetic disk.

In addition, an audit log is maintained by the storage device for function calls, such as the standard ATA download microcode function call. At the start of this function call, a new entry is created in the audit log. As this function executes, the fields of this new entry are filled in, including data on the authenticated user who invoked this function. When this function completes, its final status is filled in.

Method 400, as described herein, provides a number of advantages over methods known in the art for downloading firmware to a storage device. First, firmware downloads are protected with an additional layer of encryption, i.e., with the permission slip, over and above any other encryption schemes used to establish a secure link between host and storage device. Second, password strength is assured for the firmware download. Unlike user-selected passwords, the permission slip of method 400 cannot be stolen or guessed, which commonly occurs when weak passwords are selected by user, e.g., dates, names, etc. This is because the permission slip is based on a random number selected in an automated fashion by the programmable device. Third, multiple firmware download sessions do not appreciably erode storage device security, even when performed by the same user during the same communication session, since a unique permission slip is issued to the host for each individual firmware download request.

Method 400 has other advantages as well. First, updating firmware is now an authenticated function. Having firmware for a device is not enough. A user must be authorized to assume the role of administrator on the particular storage device and must have been previously given the right to download firmware. Second, the update uses the existing host interface “download microcode” function and any related infrastructure that supports it. Third, the request for the permission slip and the resulting firmware image can be delivered over a network without anyone being able to snoop the contents.

While the foregoing is directed to embodiments of the present invention, other and further embodiments of the invention may be devised without departing from the basic scope thereof, and the scope thereof is determined by the claims that follow.

What is claimed is:

1. A method for updating firmware for an information storage device, comprising:
receiving a request to update firmware from a host;
generating an encryption key;
transmitting the encryption key to the host; and
receiving a new firmware from the host, the new firmware being encrypted with the encryption key.

2. The method according to claim 1, wherein the encryption key is transmitted to the host in an encrypted form, and a key that is used to encrypt the encryption key is different from the encryption key that is transmitted to the host.

3. The method according to claim 1, further comprising:
receiving user credentials from the host; and
transmitting the encryption key to the host if the user credentials are authenticated.

4. The method according to claim 3, further comprising:
establishing a unique session key; and
encrypting the encryption key using the unique session key.

5. The method according to claim 3, further comprising logging the request and data on the authenticated user in an audit log.

6. The method according to claim 1, wherein the encryption key is generated as a random number.

7. The method according to claim 1, further comprising:
decrypting the new firmware received from the host using the encryption key; and
reprogramming the information storage device using the new firmware.

8. A method for updating firmware for an information storage device, comprising:
transmitting a request to update firmware to the information storage device;
receiving an encryption key from the information storage device;
encrypting a new firmware using the encryption key; and
transmitting the encrypted new firmware to the information storage device.

9. The method according to claim 8, wherein the request and the encrypted new firmware are transmitted to the information storage device over a network.

10. The method according to claim 8, wherein the encryption key is received from the information storage device in encrypted form, and a key that is used to encrypt the encryption key is different from the encryption key that is received from the information storage device.

11. The method according to claim 9, further comprising:
transmitting user credentials to the information storage device; and
establishing a unique session key,
wherein the encryption key is encrypted using the unique session key.

12. The method according to claim 8, wherein a standard download microcode command is used to transmit the new firmware to the information storage device.

13. The method according to claim 8, further comprising:
transmitting another request to update firmware to the information storage device; and
receiving another encryption key from the information storage device, said another encryption key being different from said encryption key.

14. A hard disk drive comprising:
a microcontroller; and
a memory unit storing firmware for the microcontroller,
wherein the firmware includes instructions for causing the microcontroller to generate an encryption key in response to a request for downloading a new firmware into the microcontroller.

15. The hard disk drive of claim 14, wherein a new encryption key is generated each time a request for downloading a new firmware into the microcontroller is received by the microcontroller.

16. The hard disk drive of claim 14, wherein the encryption key is generated as a random number.

17. The hard disk drive of claim 14, wherein the firmware further includes instructions for causing the microcontroller to encrypt the encryption key and transmit the encrypted encryption key to its host.

18. The hard disk drive of claim 14, wherein the encryption key is encrypted using a session key that has been established with the host.

19. The hard disk drive of claim 14, wherein the firmware further includes instructions for causing the microcontroller to decrypt an encrypted new firmware received from the host and load the new firmware in the memory unit.

20. The hard disk drive of claim 14, wherein the firmware further includes instructions for causing the microcontroller to validate the user prior to transmitting the encryption key to the host.
